(19) United States
(12) Patent Application Publication
(10) Pub. No.: US 2009/0000268 A1
(43) Pub. Date: Jan. 1, 2009

(54) THERMONUCLEAR PLASMA REACTOR FOR ROCKET THRUST AND ELECTRICAL GENERATION

(76) Inventor: Greg J. Yurash, Sunnyvale, CA (US)

Correspondence Address: SCHNECK & SCHNECK, P.O. BOX 2-E, SAN JOSE, CA, 95109-0005, US

(21) Appl. No.: 12/051,110

(22) Filed: Mar. 19, 2008

Related U.S. Application Data
(60) Provisional application No. 60/895,874, filed on Mar. 20, 2007.

(51) Int. Cl. F03H 1/00

(52) U.S. Cl. 60/202

(57) ABSTRACT

A reactor system produces plasma rocket thrust using alpha-initiated atomic fuel pellets without the need for a critical mass of fissionable material. The fuel pellets include an outer layer reactive material to alpha particles to generate neutrons (e.g., porous lead or beryllium), an under-layer of fissionable material (e.g., thorium or enriched uranium), and an optional inner core of fusion material (e.g., heavy water ice, boron hydride). The pellets are injected one at a time into a charged reaction chamber containing a set of alpha beam channels, possibly doubling as ion accelerators, all directed toward a common point. Alpha particles converging on each successive pellet initiate an atomic reaction in the fissionable under-layer, via a neutron cascade from the pellet outer layer, producing plasma that is confined within the chamber. This may be enhanced by atomic fusion of the optional inner core. The resulting high-energy plasma creates electrostatic pressure on the chamber and is allowed to exit the chamber through a port. An ion accelerator at the exhaust port of the chamber accelerates outgoing plasma ions, possibly with added reaction mass, to generate the rocket thrust. An electric circuit that includes the charged chamber may collect the electrons in the plasma to help power the ion accelerator(s).

### CROSS-REFERENCE TO RELATED APPLICATION

This patent application claims priority under 35 U.S.C. 119(e) from U.S. Provisional Application No. 60/895,874, filed Mar. 20, 2007.

### TECHNICAL FIELD

The present invention relates to nuclear spacecraft propulsion and in particular to pulsed plasma reactors for generating rocket thrust.

### BACKGROUND ART

While humans have been to near-Earth space, and even the Moon, interplanetary manned flight is still just a dream. Other than monetary cost, a principal limiting factor to human space flight has been acceleration power available from current propulsion technology. Chemical fuel is already near its theoretical maximum efficiency and is barely able to get us off the planet. The limited heat of reaction when chemical fuel is burned or oxidized constrains its potential. A higher specific impulse fuel or motive force will be needed to make humankind a space-faring species.

As a general rule, the higher the temperature of the fuel reaction, the higher the exhaust velocity of a reaction drive, and the more efficient it is. This is measured as specific impulse. However, to be of use for human space flight, a reaction drive must also have high thrust, which comes from a combination of both exhaust velocity and the total mass ejected. The rule here is Force=Mass×Acceleration, covered by Newton's third law of motion.

Many technologies have been studied that show potential, but all suffer significant drawbacks or limitations of their own. There are a number of techniques for accelerating ions, which offer much higher specific impulse than do chemical rockets. However, all those tested so far have very low total thrust and are difficult to scale up because they are moving very small masses. They also must draw large amounts of electric or thermal power from somewhere to obtain the acceleration of the ions used for the thrust, be it a nuclear or solar power source, and these requirements further limit their scalability. In other words, the ion thrusters do not use a reaction mass that contains its own energy potential the way that chemical fuel does.

Any propulsion method that must rely on conventional nuclear power for supplemental electrical needs, becomes subject to the limitations to power inefficiencies due to the laws of thermodynamics that plague current nuclear fission power reactors. While nuclear reactors generate power from atomic fission, this is done with controlled reaction rates and preventing the reaction from growing to critical runaway conditions that cause an explosion. The energy harnessed from this method is simply in the form of heat, which is put through some kind of heat cycle engine to mechanically convert it to other forms of energy such as electricity.

The proposal that has perhaps showed the most promise to date is a pulsed nuclear direct-thrust design, like that of Project Orion pioneered by the General Atomic Corporation. This method uses known technology and is upward scalable. It uses a series of small atomic explosions from devices released behind the spacecraft to create plasma that pushes against a plate to propel the craft forward. However, the pulsed nuclear direct-thrust approach of using small independent nuclear devices is limited by the need for critical mass within the uranium trigger. There are lower limits set by how small a nuclear device dependent on critical mass can be made. The critical mass is believed to be around 57 kilograms for a single uranium-235 device, and around 18 kilograms for a single plutonium-239 device, depending on design and the purity of the fissile material. A spacecraft based on such propulsion would require many such devices. This makes the fuel load difficult to scale down. Additionally, the magnitude of explosive power released by even the smallest critical mass device is enormous, and there are the problems of radiation shielding of the crew, as well as the incidental creation of highly radioactive by-products of the explosions.

Another design with promise for scalability was the Daedalus Project study, conducted by scientists and engineers of the British Interplanetary Society, which might harness direct fusion power. A primary bottleneck to efforts to use fusion power for spacecraft propulsion is that after nearly sixty years of research, no one has yet made usable amounts of power from fusion. To date, the only certain and reliable way to trigger a fusion reaction is through a critical nuclear fission reaction initiation. It is possible to make these devices relatively clean, but it makes the superior energy of fusion practical only as you scale up from the minimum critical mass fission device size for triggering the fusion reaction. The Daedalus team proposed using small pellets containing deuterium and helium-3 and producing nuclear fusion, one pellet at a time, by means of the inertial confinement technique that compresses the pellets using electron beams. The high temperature plasma products resulting from the fusion reaction would be channeled out through the rear of the spacecraft to provide thrust. However, the demonstrations of inertial confinement fusion to date have required a set of extremely high-energy lasers (approximately 4 MJ per ignition) filling an entire building and needing electric power to operate.

Different combinations of elements (e.g., deuterium+tritium, deuterium+deuterium, deuterium+helium-3, proton+lithium-6, proton+boron-11), when caused to undergo fusion, create different forms of energy. Some create hard radiation; some cause extremes of thermal energy; and some release combinations of energy output. Fusing boron and hydrogen together may be particularly useful, because the majority energy release from this reaction is in the form of high-energy electrons and protons that could be directly captured as electrical potential.

### SUMMARY DISCLOSURE

A thermonuclear plasma reaction drive uses plasma generated by nuclear reactions to generate thrust and/or electric power. In particular, the drive uses a reaction mass in the form of electrostatically and/or electromagnetically accelerated ions from a plasma that is the product of fuel pellets ignited by means of a multi-stage reaction within an electrostatically charged chamber made of tungsten and beryllium alloy. The fuel pellets may be multi-layered spheres of sub-gram size made of an outer layer of porous lead or beryllium and an under-layer of solid uranium or thorium, surrounding a central core of deuterium/deuterium, deuterium/tritium, or hydrogen/boron fusion fuel. The process starts with alpha particle beams from a set of alpha sources, which strike the outer layer of porous lead or beryllium. The lead or beryllium's reaction to the alpha particles causes a neutron particle cascade to trigger a reaction like a critical fission process in the under-layer of uranium or thorium. The uranium's or thorium's flash fission heats and compresses a central core of fusion fuel in the pellet and causes it to initiate fusion. The fusion of the central fuel creates large amounts of high-energy electrons and alpha particles, or heat and neutrons. The surrounding electrostatically charged chamber, which can be made of a tungsten and beryllium alloy, may capture the electrons for use in load circuits, while the ions are ejected as ultra-high-speed exhaust thru a linear accelerator. The exhaust is neutralized upon exit from an electrostatic nozzle with a parallel electron gun or ring, and thus completes the electric circuit. The engine should have relatively low heat load on the components since the reaction products are electrostatically or electromagnetically isolated, and, other than the low mass electrons, do not physically touch the engine components. The engine can have very high specific impulse, the fuel has very high energy density, and thrust can be scaled up and vectored. The rocket engine thus generates both thrust and usable electricity.

The approach proposed here is to simply irradiate a mass very much smaller than critical, with a very large dose of externally generated neutrons. The multi-step process starts with an alpha particle source. The alpha particles hit the outer layer of specially constructed lead or beryllium material. Both lead and beryllium have been used in nuclear applications because they reflect neutrons and thus can help focus or confine neutrons within the critical mass. However, they also have the property of releasing neutrons when bombarded with alpha particles. By properly configuring the physical shape of the lead or beryllium, both of these properties can be used together to simulate the neutron burst of a critical mass, and thus trigger a large energy release without a critical mass being present.

Either uranium-235 or thorium-232 may be used as the fission trigger in the fuel pellets. While uranium will be easier to trigger, there are several advantages to using thorium instead of uranium. thorium is roughly twice as abundant on the Earth as uranium. While thorium does not have an inherent criticality the way that uranium does, it can be induced into fission. Because the pellet design uses an alpha particle induced neutron cascade to induce the fission, it eliminates the need for critical mass of the fissile material and allows us to downsize the working reaction. Also, thorium's reaction products should be somewhat less hazardous than uranium's.

The pellet core may be a nuclear fusion material. Fusion creates more energy for a given reaction mass than fission does. As noted above, different elemental combinations (deuterium/tritium, deuterium/deuterium, deuterium/helium-3, proton/lithium-6, proton/boron-11, etc.) release their energy in different forms. The pellets are preferably chosen to have an elemental combination that creates fusion products and energy that are directly usable in a reaction engine and thus provide high efficiency.

While fusion initiation is desirable, as long as the energy release and thrust generated by the fuel burn in this method has a higher specific impulse than a chemical rocket, it may still be worth choosing. As an example, suppose that there are physical limits to the generation the neutron flux, such that the neutron density takes too long to build to simulate a criticality in the target fissile material, but still causes what for our purposes would be considered an explosive expansion. The fuel might make half-million or even one million degree plasma, which would still be too low to use as a trigger for fusion, and represent only a partial reaction of the fission fuel. Yet this would be more than adequate as a primary fuel for generating thrust, because the purpose of the device is to generate a plasma for thrust and power generation, which will still happen at those lower plasma temperatures. In light of this possibility, achieving full supercritical fission or fusion simply improves the efficiency of the engine.

The rocket drive design creates very small nuclear explosions without the need for a critical mass of fissionable material, for the purpose of plasma thrust, up to full atomic or thermonuclear temperatures, and for electrical generation from the energy released. An evacuated chamber holds a very high voltage static charge, into which the very small, multilayered fuel capsules or pellets are introduced. Converging alpha particle beams strike the fuel pellet, which, because of the physical properties of the fuel, causes an intense burst of neutron particles to uniformly enter the fuel. This neutron flash triggers an atomic reaction in the fissionable material under-layer within the fuel with a similar effect to a supercritical event. The released fission energy may be used directly, or used to create a secondary explosion in a fusion fuel core within the pellet. The resulting high-energy plasma creates electrostatic pressure on the chamber and is allowed to exit the chamber through a port to create thrust for a rocket. Further, the electrical potential of the individual charged particles within the plasma allows the charged chamber to capture electrons and concentrate and expel positive ions. The charged particles are neutralized after exiting the chamber and the electrons have passed through working circuits. The electrical potential on the chamber may be used in a circuit for any electrical purpose. The outgoing moving plasma may also be used to generate additional electricity by way of magneto-hydrodynamics, or to generate additional thrust for a rocket by way of electrostatic or electromagnetic linear acceleration. Injecting more charged particles into the accelerator portion of the engine may create even more thrust.

The resulting engine or rocket is both throttle adjustable and vector controllable by changing the amount of fuel burn, changing the strength of the linear accelerator, and varying the charge balance on the multi-segment output nozzle. For simple electrical generation purposes, there will also be multiple avenues for thermal co-generation, and the spent exhaust stream can be captured for recycling still usable materials, and for sequestering of the no longer usable by-products, and to contain possible hazardous by-products.

The design of this engine is self-powering in that the fuel contains its own energy the same way chemical fuel or a nuclear fission device does, rather than requiring a continuous external power source. Only a set of alpha sources is needed to trigger the pellet reactions. The engine can also supply its own supplemental electric power via the plasma products of the reaction. The creation of plasma will result in high-energy electrons that can be captured and harnessed. While the supplemental electricity could also be used for powering other on-board spacecraft systems, the primary use for the surplus electric power would be for increasing the usable thrust of the engine by augmenting the amount of reaction mass available to be accelerated, as well as used by the linear accelerator nozzle of the engine to further accelerate the reaction mass to near relativistic speeds. Hence, the plasma ions, in addition to already having a much higher temperature than reaction products of chemical rockets, can be accelerated to even higher exhaust speeds by electrostatic and magnetic forces that are well understood. This engine offers the thrust needed for massive payloads and provides long duration acceleration needed for achieving short interplanetary travel times.

### BRIEF DESCRIPTION OF THE DRAWINGS

FIG. 1 is schematic sectional diagram of a fuel pellet for use in the reactor of the present invention.

FIG. 2 is a schematic plan view of the elements of a plasma reactor in accord with the present invention.

### DETAILED DESCRIPTION

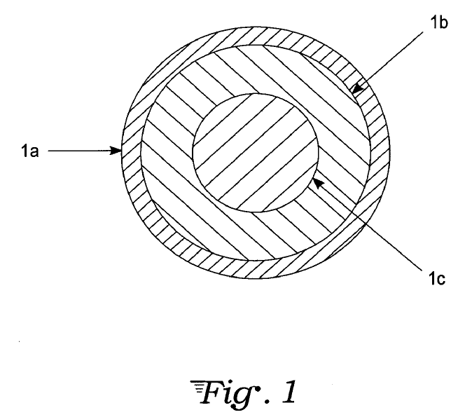

With reference to FIG. 1, a fuel pellet for use in a plasma reactor in accord with the present invention may be a small multilayer bead (about the size of a grain of sand or rice) of concentric spheres including the following structural elements: a neutron-cascade-generating outer layer 1a, a solid fissile material under-layer 1b, and an optional fusion material core 1c.

The outer layer 1a may be composed of lead or beryllium and should be made porous. Lead or beryllium spins-off neutrons when struck by alpha particles. A porous structure will provide maximum surface area and allow deep saturation of the lead or beryllium by the alpha particles, inducing a maximum neutron flux. It also provides channels for the resulting neutrons to penetrate into the uranium layer, and further reflect and concentrate neutrons in the area of the inner layer. The porous physical structure might look like a natural sea-sponge, or perpendicular nanotubes like hair standing on end.

There are numerous methods by which it may be possible to make the lead or beryllium porous, including partially fused nanospheres, micro- or nano-scale wire mesh layers, grown nano-structures or chemical process growth, deposition or etching, or fractal coatings. The optimum porosity and thickness of the lead or beryllium layer will need to be determined by experiment and will vary according to the fission requirements of the under-layer material.

The outer layer of lead or beryllium needs to be optimized in thickness and porosity for its reactivity to alpha particles and reflectivity to neutrons. A very large and rapid neutron flux reaction is paramount. In standard fission devices of critical mass, the fission cascade reaction self-creates approximately 10²⁷ neutrons within the fissionable material in about a microsecond. Given the very small fissionable mass in the proposed target fuel, a smaller quantity on the order of 10²¹ neutrons from the outer layer 1a may suffice, although similar timescales may be needed. To date, there have been very few experiments exploring this regime, given that research into the alpha reactivity of lead or beryllium has centered mainly on controlled fission reactions for slow thermal reactors. Thus, some experimentation will be needed to identify the optimum design choices for this application.

The under-layer 1b may be composed of highly enriched or purified uranium-235 or thorium-232, or some other known fissile fuel material. Uranium would be the easier fuel to initiate cascade fission in because it also multiplies neutron production by 2 or 3 to 1, but the process is otherwise the same as thorium. Thorium also fissions when exposed to free neutrons of certain energies. The speed of the reaction is dependent on the amount of neutrons per unit of time of exposure. With a sufficiently high level of exposure, the uranium or thorium fission should create energy release conditions similar to a runaway critical reaction in uranium without the need for a naturally critical mass. The speed and amount of thorium or uranium fissioning will determine how hot the fuel burn is, and how compressed the inner core becomes, if there is one. The presence of a light element central core in the pellet could also serve as a moderator for fast neutrons crossing it, and since the outer layer is partially reflective to neutrons, will help to assure the fission process.

A thorium-based fuel load would be of lower toxicity and radioactivity prior to use compared to enriched uranium, and relatively accident safe, meaning that mixing, mechanical compression, or exposure to chemical explosion or fire can not set off a chain reaction. Thorium in particular is incapable of self-induced critical fission regardless of mass or density. Also, the radioactive byproducts from thorium fuel should be relatively low and short-lived (500 years as opposed to 10,000 years or more from uranium or plutonium fuel) and less toxic (no plutonium and no U238).

If uranium is chosen as part of the fuel mix rather than thorium, more care will need to be made in the storage of the fuel pellets to avoid possibilities of accidental critical mass concentrations. Care will also need to be made to minimize possible accidental exposure of the pellets to any alpha particle sources outside of the reaction chamber.

The optional fusion inner core 1c may be some combination of deuterium and tritium, deuterium alone (for a D/D reaction), deuterium and helium-3, hydrogen (proton source) and lithium-6, hydrogen and boron-11. Assuming that the higher the initial fuel density and the fewer the non-fusion components, the better the implosion heating and compression will work at triggering fusion on the pellet core, the core material would preferably be in solid or liquid form to increase initial density, provided there are not too many non-fusible elemental contaminants that might suppress the fusion process. For example, it might be possible to use a heavy-water ice ball (D₂O or T₂O or both) in the center of the pellet. Lithium-6 could be used as a tritium source via the reaction, ⁶Li+n [symbol] ³H (2.75 MeV)+α (2.05 MeV), allowing the use of solid lithium-6 deuteride as a fusion fuel in D/T reactions. Boron hydride is also a solid, and while some forms of boron hydride are chemically very reactive, others are less so. Nevertheless, it is believed that even a compressed gas form of fusion fuel could be workable.

The manufacturing of the central fusion core 1c, if present, would greatly benefit from using a solid substance or a packable compound. A high quality spherical shape can be achieved through a flash freeze of liquid droplets ejected from a nozzle while dropped in a cold chamber, much the way that ball bearings are made. Alternatively, compression molding and subsequent polishing could make the spherical solid cores. The fissionable material could be made to form a spherical core in the same way, if used alone. When used with a fusion core 1c, the fissionable under-layer 1b can be made to coat the core 1c by a variety of methods. The choice of coating method will depend upon whether or not the core material can tolerate high temperatures without melting or chemically decomposing. Possible coating techniques include compression molding and polishing, low temperature vapor deposition (which doesn't require subsequent polishing), sputtering and polishing, and high temperature vapor deposition. Established safety protocols will be followed for handling the uranium or thorium material and when cleaning the coating equipment.

The uranium's or thorium's flash fission heats and compresses the central core of D/T or boron/hydrogen in the fuel pellet and causes it to initiate fusion. The fusion of the core fuel creates large amounts of high-energy electrons and alpha particles, or large amounts of neutrons, as well as high-energy plasma. D/D or D/T has advantages of their own, in that they would be almost ten times easier to initiate, and the additional neutrons would serve to assist a more complete burn of the fission trigger fuel.

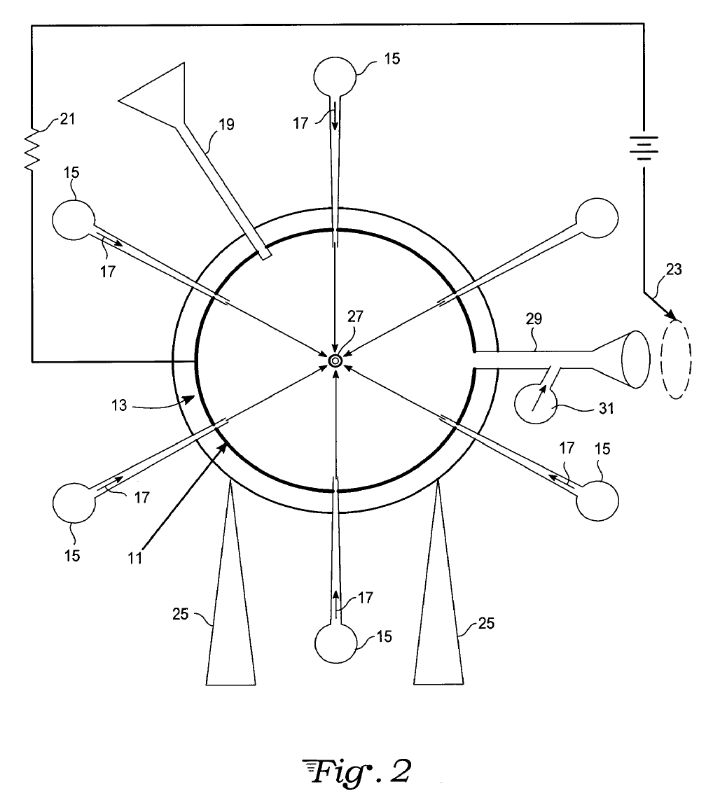

With reference to FIG. 2, the plasma reactor includes a charged reaction chamber 11. The reactor chamber is made of tungsten and beryllium, perhaps as an alloy. It must conduct electricity and hold a charge, be very strong to contain high pressures and stress, be thermally conductive and resist high heat, and be as reflective to neutrons as possible.

A coolant 13, surrounding the chamber's inner wall or in fluid conduits embedded within the chamber wall, helps maintain thermal equilibrium in the reactor vessel and prevent it from melting. Additionally, it should absorb or help stop neutrons from passing out of the reaction chamber. It should be a heat carrier so that it can pass through a heat exchanger, possibly for co-generation of electricity. A high flow rate of water may serve this purpose, although other coolant may also work.

An alpha particle source 15, such as curium-244 (with a half-life of 19 years), emits alpha particles. Since alpha particles carry a strong positive charge, it should be possible to control, bottle and accelerate them using electric and electromagnetic fields. Thus, these alpha particles can be electromagnetically trapped and then accelerated in a beam 17 directed at the fuel pellets 27 when needed. The source may be singular with multiple beam channels, or multiple sources with their own beam channels. This results in a low-energy input initiator for the alpha particles, but may need some charge time to collect sufficient quantities of alpha particles.

A high volume alternative would be to simply ionize helium in an electric arc and electrostatically isolate the ions as the source alpha material and then electromagnetically direct and accelerate them to the target 27. The multiple electromagnetically channeled beams 17 of alpha particles are focused on the center of the reactor 11, fired in unison when a fuel pellet 27 is present. The key is to aim and fire them at a target on command with a specific energy delivery.

Given that the reaction needs an initiation from high-energy alpha particles, passing helium gas through an electric arc is a particularly good candidate for providing a source of alpha particles, as the volume of ions per unit time will be high and the energy level of the ions can be made high. The electrical field inside the positively charged reaction chamber 11 will itself accelerate the resulting ions 17 up to MeV energy levels. Since the chamber 11 is spherical, it will naturally act as a focusing agent of the ions 17 toward the target fuel 27 delivered to the chamber's center.

A fuel injector 19 introduces the fuel pellets 27 into the chamber 11 at timed intervals. The injector mechanism could take many forms, from mechanical, to electromagnetic guns. If the fuel pellets 27 also have a positive charge on them, they should naturally find the center of the chamber 11, although this may not be necessary. If introduced shortly following a previous ignition, there may be sufficient alpha density in the central chamber that the pellet 27 will ignite without a specific particle beam trigger once-reactions are underway. This will also depend on flow rate of plasma out of the chamber 11.

The chamber 11 is part of an electrical work circuit 21. The positively charged chamber 11 receives high-energy electrons from the fusion reaction, channels them through circuits to do useful work, and then delivers them to an electron gun 23 for neutralizing the outbound ion flow. The electron gun 23 completes the circuit with the ion flow out of the accelerator and exhaust system 29.

Insulator supports 25 for the chamber 11 need to be electrically non-conductive, poor thermal conductors, and be very strong. Since the reactor chamber 11 must be electrically charged to harness both electric flow and provide ion control, it will need to be electrically isolated from its surroundings. Since the chamber 11 also will be providing part of the thrust energy in the rocket system, the supports will need to connect it to its parent vehicle or facility and be able to transfer its kinetic energy.

An electromagnetic linear accelerator 29 directs the flow of ions out of the reaction chamber 11 and increases the ion velocity beyond that of the expanding plasma. A supplemental ion injector 31 may introduce additional ions into the acceleration phase of the plasma to add working mass to the thruster. In the case of electric power generation without thrust, the accelerator structure 29 may be used for magneto-hydrodynamic electric generation.

Fuel ignition has several components and steps. Fuel pellets 27 are shot in succession into the reaction chamber 11. A multi-sided bombardment of alpha particles 17 should trigger a multistage reaction. In particular, the porous structure of the lead or beryllium outer layer 1a has a very large effective surface area. The porous lead or beryllium gets saturated by the alpha particles and emits free neutrons. A large flux of neutrons will reflect around inside the porous lead or beryllium. Roughly half the neutrons should pass through the porous structure into the underlying layers 1b and 1c of the pellet. The neutron flux will be semi-trapped inside by the surrounding lead or beryllium 1a, and induce rapid fission in the uranium or thorium under-layer 1b. Since there will be less than critical mass of fissile material in the fuel pellet's under-layer 1b, and thorium does not self-propagate cascade fission, the neutron burst will need to be intense enough that it replicates critical-mass fission conditions, requiring that at least 2% of the mass must undergo fission in sub-microsecond time scales. This will produce extreme temperatures in resulting plasma and can be used directly as thermal energy in the plasma, or be used to trigger a fusion process in the central core 1c. The rise in temperature and pressure from the surrounding fission should be enough to trigger a thermonuclear chain reaction in a central fuel core of elements that can fuse. Just enough uranium or thorium should be used to cause implosive compression and heating of the inner core 1c to fusion conditions. Since an alpha-generated neutron cascade induces the initiating fission, a critical mass of fissile material is not required, and thus the size of the fuel load and resulting plasma can be engineered for very small sizes as compared to traditional critical mass technology.

An evacuated containment vessel 11 consisting of layers or alloys of tungsten and beryllium, will capture electrons and reflect neutrons. This containment vessel 11 will be pre-charged with sufficient voltage to isolate the plasma from the walls and perhaps help compress it a little, since there will be a surrounding repulsive force on the heated ions. By the proper application of a pre-charge on the walls of the container vessel 11 it is possible to capture the high-energy electrons from the reaction to do useful electrical work. A balance can be found for the right voltage level, based on the expected energy level of the electrons and ions emitted during nuclear reaction. The container and electrostatic fields do not need to confine the plasma to fusion initiation conditions the way that current fusion research is attempting, only to maintain voltage control and physical containment.

The container vessel charge should be controlled so that the positively charged ions can be exhausted though an electromagnetically controlled port leading into ion accelerator 29. An electromagnetically confined escape route for the ion plasma would allow ions to squeeze through multiple stages of pulsed electromagnetic rings of the accelerator 29, further speeding it, and providing thrust by timed linear accelerator pulse action made available by the high electrical output of the engine. The outgoing plasma may be neutralized by a parallel electron gun/ring 23 at the exit, thus creating a circuit loop that generates both usable electric service and high-speed exhaust. If the electrostatic exhaust nozzle and electron gun 23 are of a segmented design, it will be possible to provide vectored thrust control by varying the voltage to the segments and thus deflect the angle of the output beam.

The reactor chamber 11 will be an alpha and neutron particle rich environment during operation. Further, given the high voltage on the spherical container, the center of the reactor chamber 11 should contain fairly high-density plasma. Since, by design, alpha particles and neutrons trigger the fuel pellet reactions, this environment inside the reactor chamber 11 may be sufficient to sustain continuous fusion, if fuel pellet insertion by the injector 2e is timed properly and balanced with the outgoing mass used for thrust.

This type of reaction drive should be capable of super high specific impulse, many orders of magnitude better than chemical rockets. Reaction gas velocities could be any conceivable speed, limited only by the tradeoff between the desired speed and the weight of the linear accelerator 29. Exhaust speeds of ¼ to ½ the speed of light may be practical. Since no physical contact is made with the reaction products or exhaust other than the electrons in the main chamber, temperature control of surfaces should be no more of a problem than with chemical reactions now in use, despite the vastly higher temperature of the reaction products themselves. Radiant heat and neutron radiation loads from the fission reactions will dictate the amount of waste heat to be controlled. Thus reaction gas can be any conceivable temperature right up to full fusion temperatures.

Additional plasma injectors 31 into the linear induction stream could augment available thrust. For example, a reaction mass could be derived from water passing through electric arcs. Replacement reaction mass can be picked up anywhere in the solar system there is water ice. Water stored as additional reaction mass for deceleration can also be used by the crew as shielding between the reactor and the rest of the spacecraft and against cosmic radiation in interstellar space, but will likely need to be nearly used up for reaction mass by the time of arrival orbit. Cargo-only craft are not required in most cases to carry reserve water for shielding, unless this is part of, or required for, the cargo to be delivered.

### Derivative Applications:

Because of the high specific impulse, efficiency and very high energy density of the fuel, sufficient fuel can be stored for long duration acceleration, resulting in extreme cruise velocities and high payload capacities for interplanetary and even interstellar ships. Interplanetary craft aught to be able to attain peak velocities of up to half a million kilometers per hour with nearly constant acceleration and deceleration profiles, giving possible transit times to Mars in a week, and the moons of Saturn in two weeks, with enough fuel for multiple way-points, and with cargo and supplies for long duration stays (multiple months). Since maximum vehicle velocity is a function of the crafts total mass, and the exhaust velocity and total energy delivered by the fuel load, interstellar craft may be able to attain speeds of ½ light, limited by the diminishing returns as craft velocity exceeds exhaust velocity (peaking at about twice exhaust speed).

The high velocities eliminate the need for complex planetary trajectories, and will allow almost line of sight flying with minimal concern for orbital dynamics other than individual orbital insertions. Also, constant acceleration and deceleration, with only brief weightlessness at the turnaround point, should keep the crew in good physical condition on interplanetary flights. Interstellar trips will likely still involve long duration coasting conditions, necessitating rotational gravity simulation.

Interstellar craft could receive additional orbital escape boosts from stationary engines. For example, an outbound craft from the Moon could deploy its electromagnetic sail, (and perhaps with another strong field around the craft for occupant safety). Then several stationary thrusters mounted on the moon would target their jets at the huge area of the sail, giving the ship a big initial shove out of orbit with minimal use of onboard fuel, perhaps accelerating the ship for several hundred thousand kilometers out. This could even be done relay style between the giant planets on the way out, using a combination of gravity assists and plasma jet pushes from engines on the moons of these planets as they go by. Only then would the ship have to start using additional onboard reaction mass to continue its outbound acceleration. Returning craft can also be similarly braked.

The electric generating capacity of the engine may be one of its defining features. It is anticipated that there will be large surpluses of electric power available. The high electric power potential of the engine may thus also be used to generate large area electromagnetic fields with the deployment of carbon nano-filament sails carrying current. These magnetic sails might look something like a spider's web or fishing net on a very large scale (multiple kilometers in diameter). This would be used for deceleration purposes against the solar wind, reducing the need for reaction mass.

As an adjunct to the spaceship design with this kind of power generation, and the high strength of carbon nano-tube wire, an electromagnetic sail or parachute may also be suitable for aero-braking in upper atmospheres, since aero-braking causes the interdicted atmosphere to form itself into a plasma when hit at high speeds. This re-entry plasma can be electromagnetically influenced and used instead of internal reaction mass. Indeed, a very strong magnetic field around the principle spacecraft when hitting an atmosphere may provide a better heat shield than high temperature resistant materials.

The electromagnetic parachute may also be used within the inner solar system to provide low thrust with extremely low reaction mass, such as solar wind startup boosts for cargo-only craft, depending on how large the parachutes can be made further reducing reaction mass needs.

For ships flying to other systems, by the time it will need to start slowing down when approaching its destination star, the extreme speed of its approach should make the electromagnetic sail a very effective break against the opposing solar wind coming out of the target star system. Peak transit velocity will be a tradeoff with deceleration requirements for orbital insertion at the destination.

### Additional Features and Benefits:

Ground-based electric power generators may be possible, if the ion accelerator 29 is instead used as a magneto-hydrodynamic (MHD) device to slow and cool the plasma and generate additional electricity, instead of acceleration. Given that the output gas started as a nuclear fire of millions of degrees, there may also still be sufficient residual heat even after the MHD to drive a conventional heat cycle gas turbine and/or steam cycle electric generator. Ground-based power generators would need to capture the exhaust and prevent release to the environment. On the other hand, given that the output is a gas, it should be relatively easy to harvest still usable materials from the exhaust by condensation, precipitation or other means.

1. An atomic reaction system for generating rocket thrust and usable electricity, comprising:
an electrically conductive reaction chamber;
an electric circuit configured to apply an electrostatic positive charge to the reaction chamber such that the reaction chamber can function as a plasma confinement vessel and a collector of plasma electrons;
a set of beam channels through the reaction chamber directed toward a common point within the reaction chamber, the beam channels coupled to at least one alpha particle source to direct beams of alpha particles along said beam channels toward said common point;
a fuel injector coupled to a supply of atomic fuel pellets to deliver the fuel pellets one at a time to the reaction chamber such that an atomic reaction producing plasma is initiated at the common point by the beams of alpha particles, the fuel pellets having at least an outer layer reactive to the alpha particles to produce neutrons and an under-layer containing atomic fissionable material reactive to the neutrons; and
an ion accelerator coupled to the reaction chamber at an electromagnetically-controlled exhaust port to receive outgoing plasma and powered by the electric circuit to accelerate positive ions of the outgoing plasma to create thrust.

2. The atomic reaction system as in claim 1, wherein the fuel pellets further include an inner core of fusion material compressible by the fissionable under-layer during the atomic reaction.

3. The atomic reaction system as in claim 1, wherein the beam of alpha particles is derived from a source of alpha-emitting material.

4. The atomic reaction system as in claim 1, wherein the beam of alpha particles is derived from helium ionized by an electric arc, the beam channels also functioning as accelerators of the ionized helium.

5. The atomic reaction system as in claim 1, wherein the ion accelerator is also coupled to a source of additional reaction mass that can be controllably introduced into the outgoing plasma.

6. The atomic reaction system as in claim 1, wherein the ion accelerator includes an electrostatic exhaust nozzle at its exit with an electron gun to provide vectored thrust control and to neutralize the accelerated plasma ions.

7. A multi-layer alpha-initiated atomic fuel pellet, comprising:
an outer layer reactive to alpha particles to produce neutrons; and
an under-layer containing atomic fissionable material reactive to neutrons to cause an atomic reaction producing plasma.

8. The atomic fuel pellet as in claim 7, further comprising an inner core of fusion material compressible by the fissionable under-layer during an atomic reaction.

9. The atomic fuel pellet as in claim 8, wherein the fusion material of the inner core is selected from the group consisting boron-11 hydride, lithium-6 deuteride, and frozen heavy water containing any of deuterium, deuterium plus tritium, or deuterium plus dissolved helium-3.

10. The atomic fuel pellet as in claim 7, wherein the fissionable material in under-layer comprises any of highly enriched uranium, and thorium-232.

11. The atomic fuel pellet as in claim 7, wherein the outer layer is composed of one or both of porous lead and beryllium.

12. A method of producing rocket thrust in an atomic reaction system, comprising:
injecting atomic fuel pellets one at a time toward a common point within a charged reaction chamber, the fuel pellets having at least an outer layer reactive to alpha particles so as to produce neutrons and an under-layer containing atomic fissionable material reactive to said neutrons;
directing a set of alpha particle beams toward the common point in the reaction chamber such that an atomic reaction is initiated in the fuel pellets producing plasma, the plasma being contained by the charged reaction chamber; and
accelerating outgoing plasma ions received at an electromagnetically-controlled exhaust port of the reaction chamber so as to create thrust.

13. The method as in claim 12, wherein the fuel pellets further include an inner core of fusion material compressible by the fissionable under-layer during an atomic reaction.

14. The method as in claim 12, wherein the alpha particles are directed toward the common point by ion accelerators.

15. The method as in claim 12, wherein additional reaction mass is added to the outgoing plasma ions prior to acceleration to increase total thrust.
